(19) United States
(12) Patent Application Publication
(10) Pub. No.: US 2014/0220952 A1
(43) Pub. Date: Aug. 7, 2014

(54) Multi-SIM Enabling Application and Use of EUICC in Legacy Terminals

(71) Applicant: NOKIA CORPORATION, Espoo (FI)

(72) Inventors: Silke Holtmanns, Klaukkala (FI); Rune Lindholm, Sottunga (FI)

(21) Appl. No.: 14/239,887

(22) PCT Filed: Aug. 22, 2011
(86) PCT No.: PCT/IB2011/053682

§ 371 Date: Apr. 18, 2014

(51) Int. Cl. H04W 4/00; H04W 8/18

(52) U.S. Cl. CPC H04W 4/001; H04W 8/183
USPC 455/418; 455/558

(57) ABSTRACT

A methods enabling use of multiple SIM applications in UICCs is described. One method includes determining whether a physical component of a device is a secure module which supports subscription provisioning. If the physical component is a secure module which supports subscription provisioning, the physical component is instructed to operate as a legacy UICC. The physical component is operated as a legacy UICC via a virtual UICC. Another method includes downloading a first subscription related data which provides information for operating in a wireless network. The first subscription related data is stored on a memory component of a device. The device includes a UICC storing a second subscription. The method also includes operating the device as a multiple profile device using the first subscription and the second subscription. Apparatus and computer readable media are also described.

### TECHNICAL FIELD

The exemplary and non-limiting embodiments of this invention relate generally to wireless communication systems, methods, devices and computer programs and, more specifically, relate to enabling use of multiple subscriber identity module applications in UICC.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:
3GPP third generation partnership project
AID application identity
ATR answer to reset
CDM code division multiplexing
CSIM code division multiple access SIM
DL downlink (eNB towards UE)
EF_{DIR} elementary file containing application identities
eNB E-UTRAN Node B (evolved Node B)
EPC evolved packet core
eUICC embedded UICC
E-UTRAN evolved UTRAN (LTE)
HARQ hybrid automatic repeat request
ISIM IP multimedia services identity module
LTE long term evolution of UTRAN (E-UTRAN)
MAC medium access control (layer 2, L2)
MM/MME mobility management/mobility management entity
MNO mobile network operator
NAA network access application
Node B base station
OFDMA orthogonal frequency division multiple access
PDCP packet data convergence protocol
PHY physical (layer 1, L1)
PPS protocol and parameter selection
RLC radio link control
RRC radio resource control
R-UIM removable user identity module
SC-FDMA single carrier, frequency division multiple access
SCP smart card platform
S-GW serving gateway
SIM subscriber identity module
UE user equipment, such as a mobile station or mobile terminal
UL uplink (UE towards eNB)
USIM universal subscriber identity module
UTRAN universal terrestrial radio access network
vUICC virtual UICC

A communication system known as evolved UTRAN (E-UTRAN, also referred to as UTRAN-LTE or as E-UTRA) has been specified within 3GPP. The DL access technique is OFDMA, and the UL access technique is SC-FDMA.

One specification of interest is 3GPP TS 36.300, V10.4.0 (2011-06), “3rd Generation Partnership Project; Technical Specification Group Radio Access Network; Evolved Universal Terrestrial Radio Access (E-UTRA) and Evolved Universal Terrestrial Access Network (E-UTRAN); Overall description; Stage 2 (Release 10)”.

FIG. 1 reproduces FIG. 4-1 of 3GPP TS 36.300, and shows the overall architecture of the E-UTRAN system. The E-UTRAN system includes eNBs, providing the E-UTRA user plane (PDCP/RLC/MAC/PHY) and control plane (RRC) protocol terminations towards the UE. The eNBs are interconnected with each other by means of an X2 interface. The eNBs are also connected by means of an S1 interface to an EPC, more specifically to a MME (Mobility Management Entity) by means of a S1 MME interface and to a Serving Gateway (SGW) by means of a S1 interface. The S1 interface supports a many-to-many relationship between MMEs/S-GW and eNBs.

Reference can also be made to 3GPP TS 31.102 V10.2.0 (2011-06) Technical Specification 3rd Generation Partnership Project; Technical Specification Group Core Network and Terminals; Characteristics of the Universal Subscriber Identity Module (USIM) application (Release 10).

3G cards are UICCs and store a SIM/USIM application. Previous 2G cards are referred to simply as SIM cards. A conventional UICC card or SIM card is issued by an operator and is used with one radio instance. As such, no problem is presented for the operator or some requestor to locate a needed application on the card.

Various devices may allow a user to access multiple subscriptions from the same device via a smart card platform (SCP). This smart card platform may be hosted by a removable module like today or be embedded. Another example is a new phone that may include additional card slots which enable the additional subscriptions. Some UICC (e.g., eUICC, a universal integrated circuit card, etc.) even allow several applications on the same card (e.g. USIM and ISIM or multiple USIMs/ISIMs). In other devices, a subscription may be downloaded to the device over the air or over other bearers like WLAN. An eUICC present in the terminal may store applications from multiple operators and/or different security modules in the same terminal that hold the same application. See further: 3GPP TR 33.812 V9.2.0 (2010-06), “3rd Generation Partnership Project; Technical Specification Group Services and System Aspects; Feasibility study on the security aspects of remote provisioning and change of subscription for Machine to Machine (M2M) equipment (Release 9)”. Such a download mechanism would enable users to choose the best operator, e.g., depending on their location or service need.

What is needed is a means for older, legacy systems, which may not be fully compatible with an eUICC and/or has a limited number of card slots, to be able to access functionality available in newer phones.

### SUMMARY

The below summary section is intended to be merely exemplary and non-limiting.

The foregoing and other problems are overcome, and other advantages are realized, by the use of the exemplary embodiments of this invention.

In a first aspect thereof an exemplary embodiment of this invention provides a method enabling terminals to use a single SIM as multiple SIMs. The method includes determining whether a physical component of a device is a secure module which supports subscription provisioning. In response to determining that the physical component is a secure module which supports subscription provisioning, the physical component is instructed to operate as a legacy UICC. The method also includes operating the physical component as a legacy UICC via a virtual UICC.

In another aspect thereof an exemplary embodiment of this invention provides a method enabling terminals to use a single SIM as multiple SIMs. The method includes downloading a first subscription related data to a device. Subscription related data provides information for operating in a wireless network. The first subscription related data is stored on a memory component of a device. The device includes a UICC storing a second subscription. The method also includes operating the device as a multiple profile device using the first subscription and the second subscription.

In a further aspect thereof an exemplary embodiment of this invention provides an apparatus enabling terminals to use a single SIM as multiple SIMs. The apparatus includes at least one processor; and at least one memory which includes computer program code. The at least one memory and the computer program code are configured to, with the at least one processor, cause the apparatus to perform at least the following: to determine whether a physical component of a device is a secure module which supports subscription provisioning; in response to determining that the physical component is a secure module which supports subscription provisioning, to instruct the physical component to operate as a legacy UICC; and to operate the physical component as a legacy UICC via a virtual UICC.

In another aspect thereof an exemplary embodiment of this invention provides an apparatus enabling terminals to use a single SIM as multiple SIMs. The apparatus includes at least one processor; and at least one memory including computer program code. The at least one memory and the computer program code are configured to, with the at least one processor, cause the apparatus to perform at least the following: to download a first subscription related data to a device, where subscription related data provides information for operating in a wireless network; to store the first subscription related data on a memory component of a device, where the device includes a UICC storing a second subscription; and to operate the device as a multiple profile device using the first subscription and the second subscription.

In a further aspect thereof an exemplary embodiment of this invention provides an computer readable medium enabling terminals to use a single SIM as multiple SIMs. The computer readable medium is tangibly encoded with a computer program executable by a processor to perform actions including: determining whether a physical component of a device is a secure module which supports subscription provisioning; in response to determining that the physical component is a secure module which supports subscription provisioning, instructing the physical component to operate as a legacy UICC; and operating the physical component as a legacy UICC via a virtual UICC.

In another aspect thereof an exemplary embodiment of this invention provides an computer readable medium enabling terminals to use a single SIM as multiple SIMs. The computer readable medium is tangibly encoded with a computer program executable by a processor to perform actions including: downloading a first subscription related data to a device, where subscription related data provides information for operating in a wireless network; storing the first subscription related data on a memory component of a device, where the device includes a UICC storing a second subscription; and operating the device as a multiple profile device using the first subscription and the second subscription.

In a further aspect thereof an exemplary embodiment of this invention provides an apparatus enabling terminals to use a single SIM as multiple SIMs. The apparatus includes means for determining whether a physical component of a device is a secure module which supports subscription provisioning; means for instructing the physical component to operate as a legacy UICC in response to determining that the physical component is a secure module which supports subscription provisioning; and means for operating the physical component as a legacy UICC via a virtual UICC.

In another aspect thereof an exemplary embodiment of this invention provides an apparatus enabling terminals to use a single SIM as multiple SIMs. The apparatus includes means for downloading a first subscription related data to a device, where subscription related data provides information for operating in a wireless network; means for storing the first subscription related data on a memory component of a device, where the device includes a UICC storing a second subscription; and means for operating the device as a multiple profile device using the first subscription and the second subscription.

### BRIEF DESCRIPTION OF THE DRAWINGS

The foregoing and other aspects of exemplary embodiments of this invention are made more evident in the following Detailed Description, when read in conjunction with the attached Drawing Figures, wherein:

FIG. 1 reproduces FIG. 4-1 of 3GPP TS 36.300, and shows the overall architecture of the E UTRAN system.

FIG. 2 shows a simplified block diagram of exemplary electronic devices that are suitable for use in practicing various exemplary embodiments of this invention.

FIG. 3 shows a more particularized block diagram of an exemplary user equipment such as that shown at FIG. 2.

FIG. 4 shows a simplified block diagram of an exemplary electronic device that is suitable for use in practicing various exemplary embodiments of this invention.

FIG. 5 depicts a block diagram of various profiles usable by an exemplary electronic device that is suitable for use in practicing various exemplary embodiments of this invention.

FIG. 6 is a logic flow diagram that illustrates the operation of an exemplary method, and a result of execution of computer program instructions embodied on a computer readable memory, in accordance with various exemplary embodiments of this invention.

FIG. 7 is another logic flow diagram that illustrates the operation of a further exemplary method, and a result of execution of computer program instructions embodied on a computer readable memory, in accordance with various exemplary embodiments of this invention.

### DETAILED DESCRIPTION

Exemplary embodiments in accordance with this invention enable an existing phone (e.g., a legacy phone) to be “enhanced” in order to support multi-SIM, for example, by a downloaded subscription. This enhancement can take place at a physical shop, or could be an application downloaded or pushed to the device. Exemplary embodiments in accordance with this invention also allow a legacy phone to use an eUICC. The phone may be equipped with an additional card (e.g., a memory card) or an UICC card which supports downloading of subscriptions. Exemplary embodiments in accordance with this invention also provide a downloadable application which can upgrade a legacy device so that an eUICC can be inserted in a legacy phone and operate as a legacy UICC.

An eUICC may refer to additional functionality available on a (reasonable) secure element. The element can be a UICC card or a secure memory card. Alternatively, an eUICC may refer to the element which provides eUICC functionality. Thus, a single subscriber identity module may appear to a terminal like multiple identity modules, e.g., by means of virtual modules. The terminal may have one physical reader.

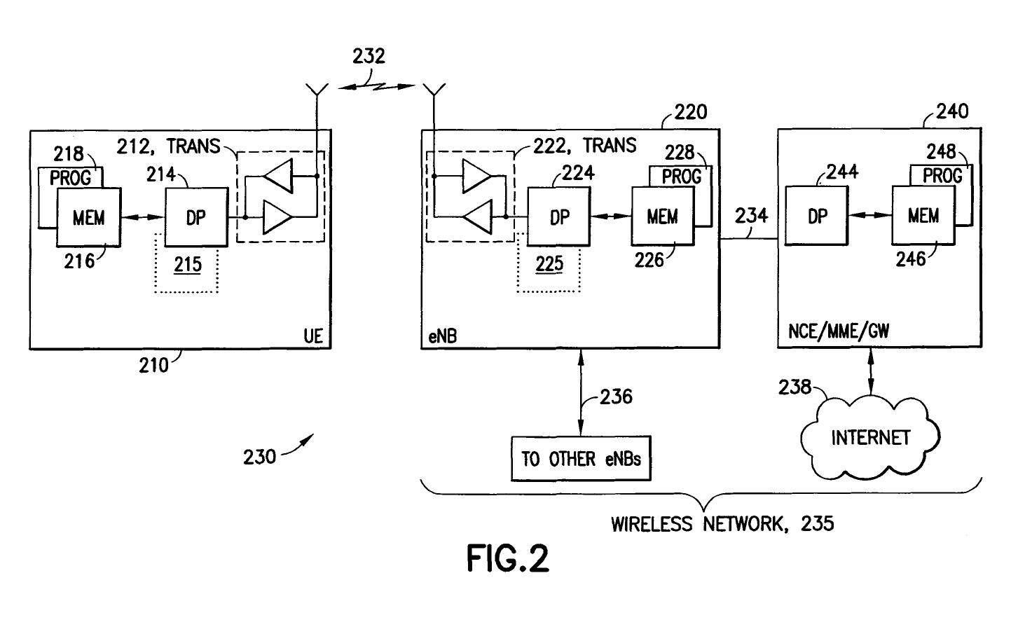

Before describing in further detail various exemplary embodiments of this invention, reference is made to FIG. 2 for illustrating a simplified block diagram of various electronic devices and apparatus that are suitable for use in practicing exemplary embodiments of this invention.

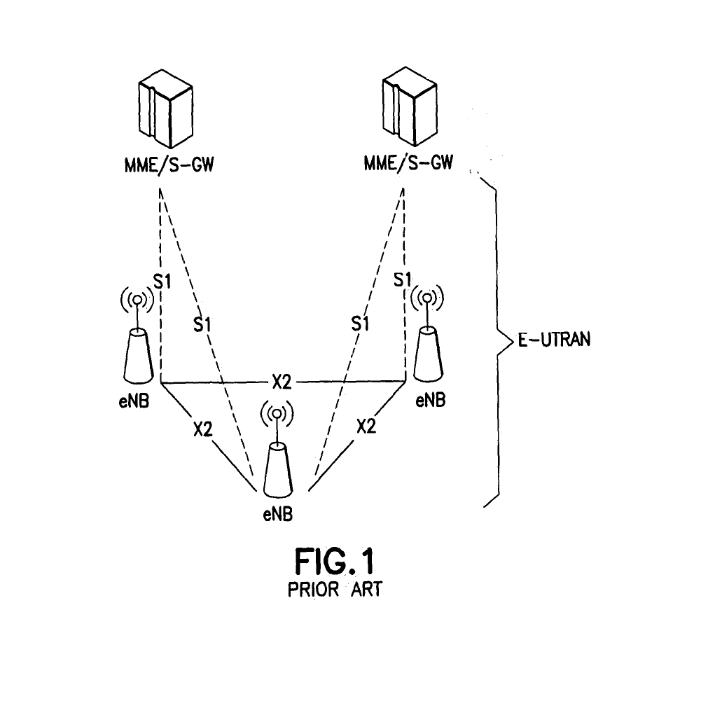

In the wireless system 230 of FIG. 2, a wireless network 235 is adapted for communication over a wireless link 232 with an apparatus, such as a mobile communication device which may be referred to as a UE 210, via a network access node, such as a Node B (base station), and more specifically an eNB 220. The network 235 may include a network control element (NCE) 240 that may include the MME/SGW functionality shown in FIG. 1, and which provides connectivity with a network, such as a telephone network and/or a data communications network (e.g., the internet 238).

The UE 210 includes a controller, such as a computer or a data processor (DP) 214, a computer-readable memory medium embodied as a memory (MEM) 216 that stores a program of computer instructions (PROG) 218, and a suitable wireless interface, such as radio frequency (RF) transceiver 212, for bidirectional wireless communications with the eNB 220 via one or more antennas.

The eNB 220 also includes a controller, such as a computer or a data processor (DP) 224, a computer-readable memory medium embodied as a memory (MEM) 226 that stores a program of computer instructions (PROG) 228, and a suitable wireless interface, such as RF transceiver 222, for communication with the UE 210 via one or more antennas. The eNB 220 is coupled via a data/control path 234 to the NCE 240. The path 234 may be implemented as the S1 interface shown in FIG. 1. The eNB 220 may also be coupled to another eNB via data/control path 236, which may be implemented as the X2 interface shown in FIG. 1.

The NCE 240 includes a controller, such as a computer or a data processor (DP) 244, a computer-readable memory medium embodied as a memory (MEM) 246 that stores a program of computer instructions (PROG) 248.

At least one of the PROGs 218, 228 and 248 is assumed to include program instructions that, when executed by the associated DP, enable the device to operate in accordance with exemplary embodiments of this invention, as will be discussed below in greater detail.

That is, various exemplary embodiments of this invention may be implemented at least in part by computer software executable by the DP 214 of the UE 210; by the DP 224 of the eNB 220; and/or by the DP 244 of the NCE 240, or by hardware, or by a combination of software and hardware (and firmware).

The UE 210 and the eNB 220 may also include dedicated processors, for example memory controller 215.

In general, the various embodiments of the UE 210 can include, but are not limited to, cellular telephones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer readable MEMs 216, 226 and 246 may be of any type suitable to the local technical environment and may be implemented using any suitable data storage technology, such as semiconductor based memory devices, flash memory, magnetic memory devices and systems, optical memory devices and systems, fixed memory and removable memory. The DPs 214, 224 and 244 may be of any type suitable to the local technical environment, and may include one or more of general purpose computers, special purpose computers, microprocessors, digital signal processors (DSPs) and processors based on a multicore processor architecture, as non-limiting examples. The wireless interfaces (e.g., RF transceivers 212 and 222) may be of any type suitable to the local technical environment and may be implemented using any suitable communication technology such as individual transmitters, receivers, transceivers or a combination of such components.

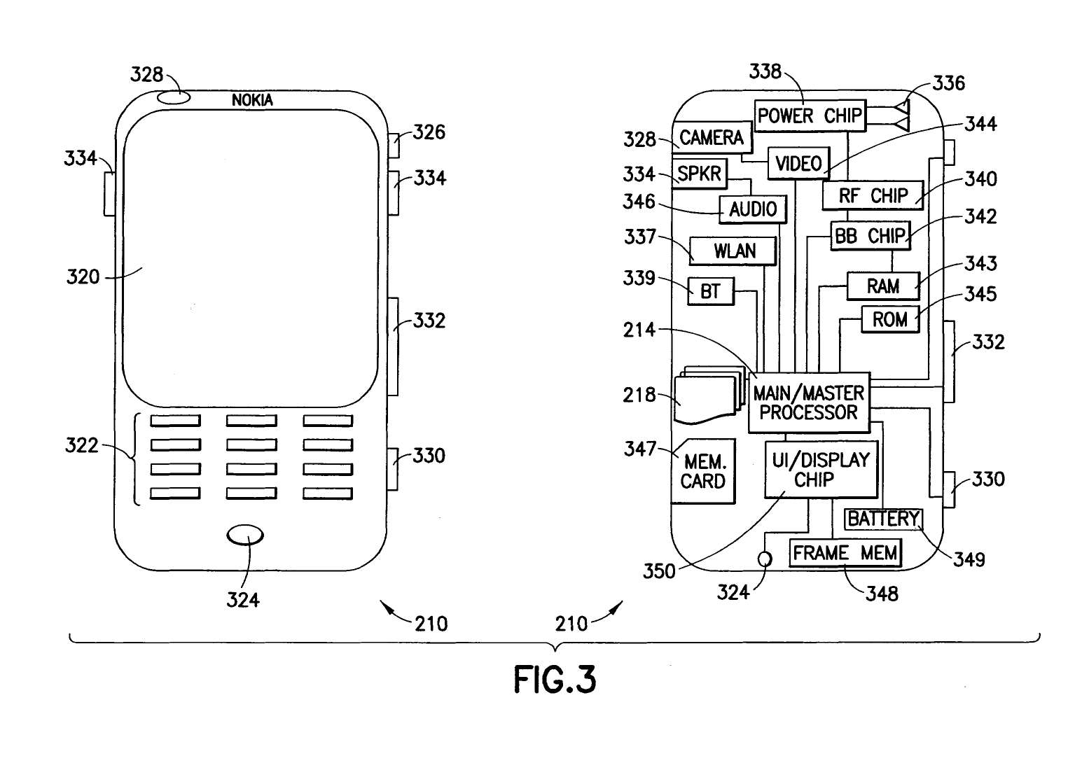

FIG. 3 illustrates further detail of an exemplary UE in both plan view (left) and sectional view (right), and the invention may be embodied in one or some combination of those more function-specific components. At FIG. 3 the UE 210 has a graphical display interface 320 and a user interface 322 illustrated as a keypad but understood as also encompassing touch-screen technology at the graphical display interface 320 and voice-recognition technology received at the microphone 324. A power actuator 326 controls the device being turned on and off by the user. The exemplary UE 210 may have a camera 328 which is shown as being forward facing (e.g., for video calls) but may alternatively or additionally be rearward facing (e.g., for capturing images and video for local storage). The camera 328 is controlled by a shutter actuator 330 and optionally by a zoom actuator 332 which may alternatively function as a volume adjustment for the speaker(s) 334 when the camera 328 is not in an active mode.

Within the sectional view of FIG. 3 are seen multiple transmit/receive antennas 336 that are typically used for cellular communication. The antennas 336 may be multi-band for use with other radios in the UE. The operable ground plane for the antennas 336 is shown by shading as spanning the entire space enclosed by the UE housing though in some embodiments the ground plane may be limited to a smaller area, such as disposed on a printed wiring board on which the power chip 338 is formed. The power chip 338 controls power amplification on the channels being transmitted and/or across the antennas that transmit simultaneously where spatial diversity is used, and amplifies the received signals. The power chip 338 outputs the amplified received signal to the radio-frequency (RF) chip 340 which demodulates and downconverts the signal for baseband processing. The baseband (BB) chip 342 detects the signal which is then converted to a bit-stream and finally decoded. Similar processing occurs in reverse for signals generated in the apparatus 210 and transmitted from it.

Signals to and from the camera 328 pass through an image/video processor 344 which encodes and decodes the various image frames. A separate audio processor 346 may also be present controlling signals to and from the speakers 334 and the microphone 324. The graphical display interface 320 is refreshed from a frame memory 348 as controlled by a user interface chip 350 which may process signals to and from the display interface 320 and/or additionally process user inputs from the keypad 322 and elsewhere.

Certain embodiments of the UE 210 may also include one or more secondary radios such as a secondary cellular radio chip, a wireless local area network radio WLAN 337 and a Bluetooth® radio 339, which may incorporate an antenna on-chip or be coupled to an off-chip antenna. Throughout the apparatus are various memories such as random access memory RAM 343, read only memory ROM 345, and in some embodiments removable memory such as the illustrated memory card 347. The various programs 218 are stored in one or more of these memories. All of these components within the UE 210 are normally powered by a portable power supply such as a battery 349.

Embodiments of this invention are most relevant to the UE 210, DP 214, MEM 216 and memory controller 215, though it is noted that other embodiments need not be disposed there but may be disposed across various chips and memories as shown or disposed within another processor that combines some of the functions described above for FIG. 3.

Processors 338, 340, 342, 344, 346, 350, if embodied as separate entities in a UE 210 or eNB 220, may operate in a slave relationship to the main processor 214, 224, which may then be in a master relationship to them. Any or all of these various processors of FIG. 3 access one or more of the various memories, which may be on-chip with the processor or separate therefrom. Similar function-specific components that are directed toward communications over a network broader than a piconet (e.g., components 336, 338, 340, 342-345 and 347) may also be disposed in exemplary embodiments of the access node 220, which may have an array of tower-mounted antennas rather than the two shown at FIG. 3.

Note that the various chips (e.g., 338, 340, 342, etc.) that were described above may be combined into a fewer number than described and, in a most compact case, may all be embodied physically within a single chip.

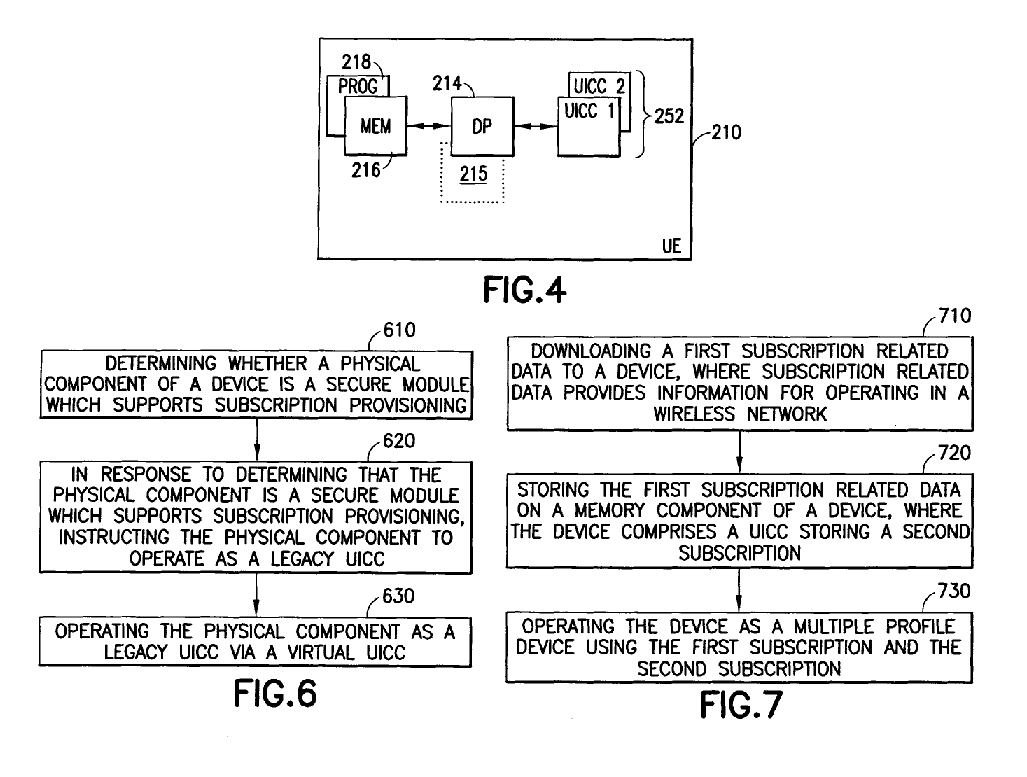

FIG. 4 shows another simplified block diagram of an exemplary electronic device that is suitable for use in practicing various exemplary embodiments of this invention. UE 210 may include one or more card 252. A card 252 may be an UICC or a SIM. A card 252 and/or MEM 216 may be removable. A subscription may be active on a card 252 or the subscription may reside on the UE 210 and be bound to the presence of the card 252.

Two cards 252 are shown, however, there may be more or less depending on the number of slots available. A first card 252 (e.g., UICC 1) may be designated as a primary subscription and a second card 252 (e.g., UICC 2) may be designated as secondary. These roles may be assigned by which slot is used for the card 252 and/or by system/user settings. Depending on the system configuration both the primary subscription and the secondary subscription may be able to receive calls and/or incoming data. Likewise, the primary subscription and the secondary subscription can individually make calls and/or establish data connections.

Various exemplary embodiments in accordance with this invention outline methods to “upgrade” an existing device (e.g., a legacy device) to enable multi-SIM use. In a first non-limiting exemplary embodiment, the user may receive a card (e.g., an UICC card or a memory card) that supports downloading of subscriptions. The upgrade may be done via an application. In a second non-limiting exemplary embodiment, a method provides for an eUICC to be used in a legacy phone by implementing the eUICC using one of the standardized “SIM” card form factors.

An application as used in the first exemplary embodiment can detect whether a physical component (e.g., a card) supports downloading of subscriptions (e.g., an eUICC) or a legacy UICC which does not support downloading. When detecting that the component is an eUICC, the terminal informs the eUICC that it is capable of handling the eUICC, with a virtual UICCs (e.g., each operator would have his own virtual UICC on the eUICC).

The terminal can detect whether or not the physical component supports downloading of subscriptions based on an ATR or by issuing a command sequence (e.g. PPS). The ATR is a set of bytes that are delivered to the terminal when the component is powered up and exit reset. The eUICC indicates in the ATR, e.g., at power up, that it is an eUICC and supports subscription download functionality. The ATR can be presented directly to an interface. It can additionally be represented in a file. Alternatively, the terminal could use a command sequence, e.g., a PPS procedure, to see if the card accepts the download of subscriptions. If the UICC doesn't accept the PPS procedure the terminal knows that the card does not accept downloading of subscriptions.

If the terminal is able to support multi-SIM use (e.g., from the radio side), then the terminal may use a PPS procedure to indicate to the eUICC that the terminal is an eUICC capable terminal. The PPS allows the terminal to tell a component (e.g., an eUICC/UICC) how to behave. The terminal can select if the component behaves like an eUICC or an UICC. A default for the physical component may be to behave as an UICC until instructed differently.

When operating as an UICC, there may not be any provisioning network access application (NAA) available or if the provisioning NAA is available it may have a separate application identity (AID) different from the operational NAAs so that it doesn't get used (e.g., in a legacy terminal). Which applications are shown to the terminal when operating as an UICC may also depends on a configuration used in a previous session. Alternatively, there may be an NAA application on an eUICC but this NAA may not be visible to the terminal when operated in the UICC mode. Thus, the NAA of the eUICC may be considered as not available.

When the eUICC detects that the terminal is eUICC enabled (e.g., in a protocol and parameter selection (PPS) procedure), the eUICC may indicate that the eUICC has a provisioning capability (e.g., by changing the content of EF_{DIR} so that the provisioning NAA AID is now part of the EF_{DIR} content and is thereby shown to the terminal). The content of the EF_{DIR} are changed so that “new” or more applications are visible to the eUICC enabled terminal. Thus, the terminal and the eUICC are aware of each other's capabilities. The eUICC may reside on an UICC card or in a second element in the terminal (e.g., a memory card).

Section 13 of 3GPP TS 31.101 V10.0.1 (2011-06) Technical Specification 3rd Generation Partnership Project; Technical Specification Group Core Network and Terminals; UICC-terminal interface; Physical and logical characteristics (Release 10), “Application independent files”, states that there are four EFs at the Master File (MF) level specified in ETSI TS 102 221 clause 13 (EF_{ICCID}; EF_{DIR}, EF_{PL} and EF_{ARR}), for 3GPP. The EF_{DIR} file contains the application identifiers (AIDs) and the application labels of the 3GPP applications present on the card. The AIDs of 3GPP applications are defined in ETSI TS 101 220. The 3GPP applications can be selected by means of the AID selection, as specified in TS 31.101. The EF_{DIR} entry is specified as not containing a path object for application selection, and it is recommended that the application label does not contain more than 32 bytes. See further ETSI TS 102 221 V8.2.0 (2009-06) Technical Specification; Smart Cards; UICC-Terminal interface; Physical and logical characteristics (Release 8).

Once an eUICC is detected and the terminal has set the eUICC into “eUICC mode”, the terminal may use the new or enhanced commands (e.g., usage of multiple application numbers, multiple radio instance iteration, enhanced user interface, etc.).

Thus, a legacy terminal running such an application and with the eUICC inserted becomes a multi-SIM terminal (e.g., by using virtual UICCs (vUICC) rather than multiple applications, e.g., SIMs, USIMs, or a combination of SIMs and USIMs). This allows UICC management mechanisms to be used by network operators which rely on multiple UICC.

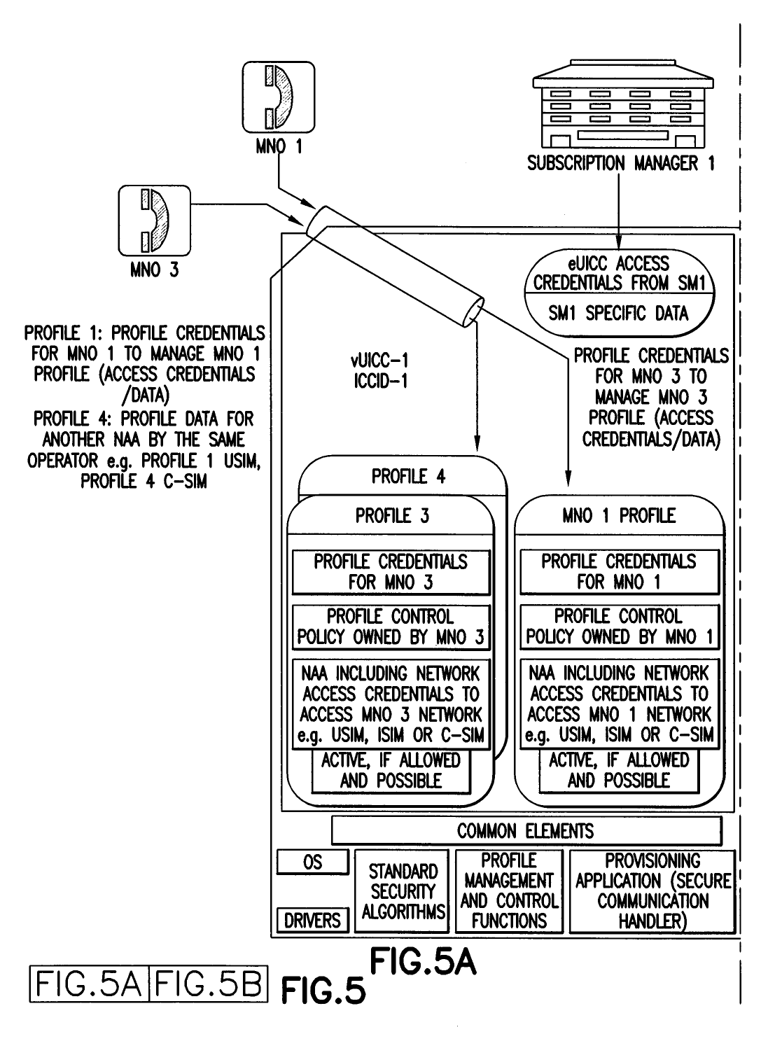

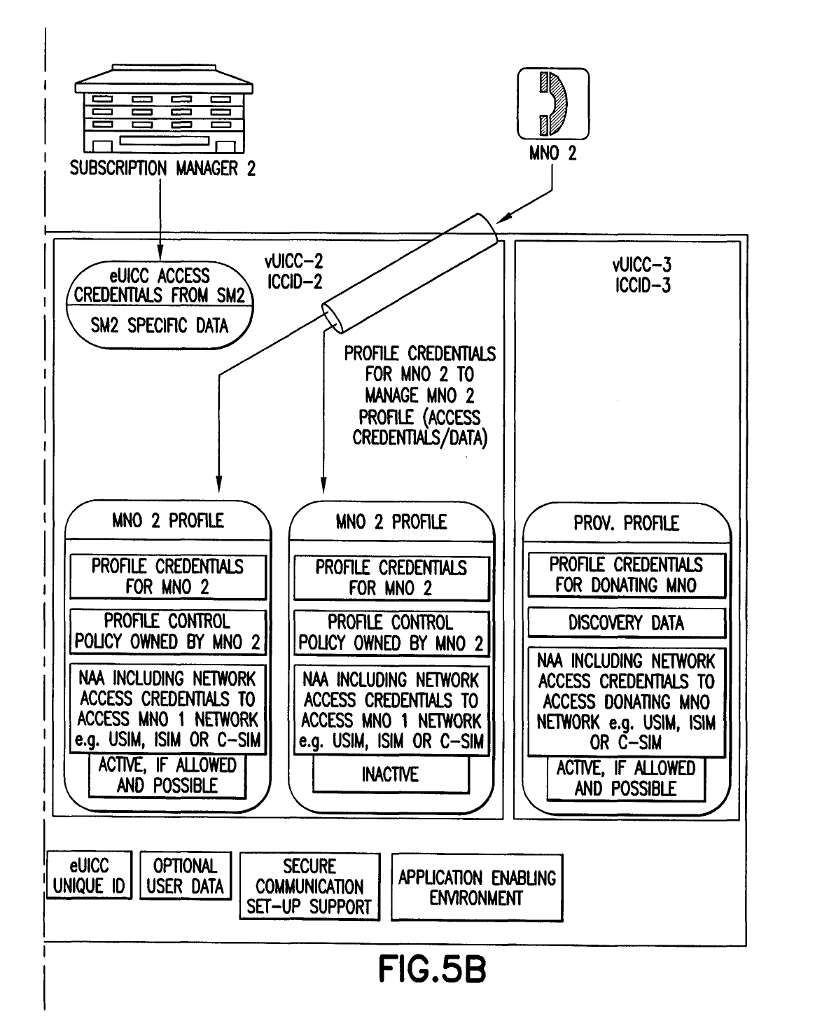

FIG. 5 depicts a block diagram of various profiles usable by an exemplary electronic device that is suitable for use in practicing various exemplary embodiments of this invention. The service control point is divided in several vUICC, each subscription manager manages one or more vUICC. The subscription manager can access the vUICCs to which the subscription manager is in possession of the relevant vUICC specific credentials. The subscription manager assists in downloading the subscriptions to the vUICC.

As shown, a first mobile network operator (MNO1) provides a first profile, MNO 1 profile. This profile is usable under a first subscription manager (SM1). This profile will allow downloading of further network access credentials. The SM1 provides eUICC access credentials and SM1 specific data. A profile includes credentials for the MNO and enable network access by containing a NAA. In addition the profile may contain credentials for the donating (MNO). NAA with network access credentials are also included in the profile. Control mechanisms (e.g., for deletion, updating, etc.) may be part of a profile's control policies and also stored in the profile.

A second mobile network operator (MNO2) provides two profiles, MNO 2 profile. These profiles are usable under a second subscription manager (SM2). The SM2 provides eUICC access credentials and SM1 specific data. One or both of these profiles may be active (e.g., if allowed and possible) while the other is inactive. Two or more profiles from different MNOs may be active at the same time to simulate a “dual or multiple SIM” terminal.

As shown, a third mobile network operator (MNO3) provides a third profile, profile 3, and a fourth profile, profile 4. These profiles are also usable under SM1. Both may be active.

Based on the foregoing it should be apparent that the exemplary embodiments of this invention provide a method, apparatus and computer progam(s) to enable use of multiple subscriber identity module applications in UICCs. It should be noted, that the embodiments contains several vUICC which are bound to specific SMs. The role of the SM can also be taken by an operator. The device may then contain one or more active subscriptions that do not interfere with each other, e.g., MNO2 has no management possibility over the MNO3 profile and vice-versa.

FIG. 6 is a logic flow diagram that illustrates the operation of a method, and a result of execution of computer program instructions, in accordance with the exemplary embodiments of this invention. In accordance with these exemplary embodiments a method performs, at Block 610, a step of determining whether a physical component of a device is a secure module which supports subscription provisioning. In response to determining that the physical component is a secure module which supports subscription provisioning, the physical component is instructed to operate as a legacy UICC at Block 620. At Block 630, the physical component is operated as a legacy UICC via a virtual UICC.

FIG. 7 is a logic flow diagram that illustrates the operation of a method, and a result of execution of computer program instructions, in accordance with the exemplary embodiments of this invention. In accordance with these exemplary embodiments a method performs, at Block 710, a step of downloading first subscription related data to a device. Subscription related data provides information for operating in a wireless network. The first subscription related data is stored on a memory component of a device at Block 720. The device includes a UICC storing a second subscription. At Block 730, the method also includes operating the device as a multiple profile device using the first subscription and the second subscription

The various blocks shown in FIGS. 6 and 7 may be viewed as method steps, and/or as operations that result from operation of computer program code, and/or as a plurality of coupled logic circuit elements constructed to carry out the associated function(s).

An exemplary embodiment in accordance with this invention provides a method enabling use of multiple subscriber identity module applications in UICCs. The method includes determining (e.g., by a processor) whether a physical component of a device is a secure module which supports subscription provisioning. In response to determining that the physical component is a secure module which supports subscription provisioning, the physical component is instructed (e.g., by the processor) to operate as a legacy UICC. The method also includes operating (e.g., by the processor) the physical component as a legacy UICC via a virtual UICC.

In a further exemplary embodiment of the method above, determining whether the physical component is an secure module which supports subscription provisioning is based upon ATR bits provided by the physical component or a command sequence.

In another exemplary embodiment of any one of the methods above, instructing the physical component is a part of a PPS procedure.

In a further exemplary embodiment of any one of the methods above, instructing the physical component includes instructing the physical component to swap contents of an elementary file.

In another exemplary embodiment of any one of the methods above, the physical component has a default setting to operate as a legacy UICC.

In a further exemplary embodiment of any one of the methods above, the physical component stores a USIM, an ISIM, a SIM, a R-UIM application and/or a CSIM.

In another exemplary embodiment of any one of the methods above, the physical component is an eUICC.

In a further exemplary embodiment of any one of the methods above, a legacy UICC is a non-embedded UICC.

Another exemplary embodiment in accordance with this invention provides a method enabling use of multiple subscriber identity module applications in UICCs. The method includes downloading (e.g., by a processor) a first subscription related data to a device. Subscription related data provides information for operating in a wireless network. The first subscription related data is stored on a memory component of a device. The device includes a UICC storing a second subscription. The method also includes operating (e.g., by the processor) the device as a multiple profile device using the first subscription and the second subscription.

In a further exemplary embodiment of the method above, operation of the first subscription is conditioned on the presence of the UICC.

In another exemplary embodiment of any one of the methods above, the memory component is removable.

In a further exemplary embodiment of any one of the methods above, the UICC is a legacy UICC or a secure module which supports subscription provisioning.

In another exemplary embodiment of any one of the methods above, the subscription includes a USIM subscription, an ISIM subscription, a SIM subscription, a R-UIM subscription and/or a CSIM subscription.

In a further exemplary embodiment of any one of the methods above, the method also includes designating one of the first subscription and the second subscription as a primary subscription and the other as a secondary subscription. The method may also include receiving an input from a user indicating which of the first subscription and the second subscription to designate as the primary subscription and/or the first subscription may be designated as the secondary subscription.

Another exemplary embodiment in accordance with this invention provides an apparatus enabling use of multiple subscriber identity module applications in UICCs. The apparatus includes at least one processor; and at least one memory which includes computer program code. The at least one memory and the computer program code are configured to, with the at least one processor, cause the apparatus to perform at least the following: to determine whether a physical component of a device is a secure module which supports subscription provisioning; in response to deteimining that the physical component is a secure module which supports subscription provisioning, to instruct the physical component to operate as a legacy UICC; and to operate the physical component as a legacy UICC via a virtual UICC.

In a further exemplary embodiment of the apparatus above, determining whether the physical component is an secure module which supports subscription provisioning is based upon ATR bits provided by the physical component or a command sequence.

In another exemplary embodiment of any one of the apparatus above, instructing the physical component is a part of a PPS procedure.

In a further exemplary embodiment of any one of the apparatus above, when instructing the physical component, the at least one memory and the computer program code are further configured to cause the apparatus to instruct the physical component to swap contents of an elementary file.

In another exemplary embodiment of any one of the apparatus above, the physical component has a default setting to operate as a legacy UICC.

In a further exemplary embodiment of any one of the apparatus above, the physical component stores a USIM, an ISIM, a SIM, a R-UIM application and/or a CSIM.

In another exemplary embodiment of any one of the apparatus above, the physical component is an eUICC.

In a further exemplary embodiment of any one of the apparatus above, a legacy UICC is a non-embedded UICC.

Another exemplary embodiment in accordance with this invention provides an apparatus enabling use of multiple subscriber identity module applications in UICCs. The apparatus includes at least one processor; and at least one memory including computer program code. The at least one memory and the computer program code are configured to, with the at least one processor, cause the apparatus to perform at least the following: to download a first subscription related data to a device, where subscription related data provides information for operating in a wireless network; to store the first subscription related data on a memory component of a device, where the device includes a UICC storing a second subscription; and to operate the device as a multiple profile device using the first subscription and the second subscription.

In a further exemplary embodiment of the apparatus above, operation of the first subscription is conditioned on the presence of the UICC.

In another exemplary embodiment of any one of the apparatus above, the memory component is removable.

In a further exemplary embodiment of any one of the apparatus above, the UICC is a legacy UICC or a secure module which supports subscription provisioning.

In another exemplary embodiment of any one of the apparatus above, the subscription includes a USIM subscription, an ISIM subscription, a SIM subscription, a R-UIM subscription or a CSIM subscription.

In a further exemplary embodiment of any one of the apparatus above, where the at least one memory and the computer program code are further configured to cause the apparatus to designate one of the first subscription and the second subscription as a primary subscription and the other as a secondary subscription.

In another exemplary embodiment of any one of the apparatus above, the at least one memory and the computer program code are further configured to receive an input from a user indicating which of the first subscription and the second subscription to designate as the primary subscription.

In a further exemplary embodiment of any one of the apparatus above, the first subscription is designated as the secondary subscription.

Another exemplary embodiment in accordance with this invention provides an computer readable medium enabling use of multiple subscriber identity module applications in UICCs. The computer readable medium is tangibly encoded with a computer program executable by a processor to perform actions including: determining whether a physical component of a device is a secure module which supports subscription provisioning; in response to determining that the physical component is a secure module which supports subscription provisioning, instructing the physical component to operate as a legacy UICC; and operating the physical component as a legacy UICC via a virtual UICC.

In a further exemplary embodiment of the computer readable medium above, determining whether the physical component is an secure module which supports subscription provisioning is based upon ATR bits provided by the physical component or a command sequence.

In another exemplary embodiment of any one of the computer readable media above, instructing the physical component is a part of a PPS procedure.

In a further exemplary embodiment of any one of the computer readable media above, instructing the physical component includes instructing the physical component to swap contents of an elementary file.

In another exemplary embodiment of any one of the computer readable media above, the physical component has a default setting to operate as a legacy UICC.

In a further exemplary embodiment of any one of the computer readable media above, the physical component stores a USIM, an ISIM, a SIM, a R-UIM application or a CSIM.

In another exemplary embodiment of any one of the computer readable media above, the physical component is an eUICC.

In a further exemplary embodiment of any one of the computer readable media above, a legacy UICC is a non-embedded UICC.

In another exemplary embodiment of any one of the computer readable media above, the computer readable medium is a non-transitory computer readable medium (e.g., RAM, ROM, a hard drive, flash memory, etc.).

A further exemplary embodiment in accordance with this invention provides an computer readable medium enabling use of multiple subscriber identity module applications in UICCs. The computer readable medium is tangibly encoded with a computer program executable by a processor to perform actions including: downloading a first subscription related data to a device, where subscription related data provides information for operating in a wireless network; storing the first subscription related data on a memory component of a device, where the device includes a UICC storing a second subscription; and operating the device as a multiple profile device using the first subscription and the second subscription.

In another exemplary embodiment of the computer readable medium above, operation of the first subscription is conditioned on the presence of the UICC.

In a further exemplary embodiment of any one of the computer readable media above, the memory component is removable.

In another exemplary embodiment of any one of the computer readable media above, the UICC is a legacy UICC or a secure module which supports subscription provisioning.

In a further exemplary embodiment of any one of the computer readable media above, the subscription includes a USIM subscription, an ISIM subscription, a SIM subscription, a R-UIM subscription and/or a CSIM subscription.

In another exemplary embodiment of any one of the computer readable media above, the actions further include designating one of the first subscription and the second subscription as a primary subscription and the other as a secondary subscription.

In a further exemplary embodiment of any one of the computer readable media above, the actions further include receiving an input from a user indicating which of the first subscription and the second subscription to designate as the primary subscription.

In another exemplary embodiment of any one of the computer readable media above, the first subscription is designated as the secondary subscription.

In a further exemplary embodiment of any one of the computer readable media above, the computer readable medium is a non-transitory computer readable medium (e.g., RAM, ROM, a hard drive, flash memory, etc.).

Another exemplary embodiment in accordance with this invention provides an apparatus enabling use of multiple subscriber identity module applications in UICCs. The apparatus includes means for determining (e.g., a processor) whether a physical component of a device is a secure module which supports subscription provisioning; means for instructing (e.g., a processor) the physical component to operate as a legacy UICC in response to determining that the physical component is a secure module which supports subscription provisioning; and means for operating (e.g., a processor) the physical component as a legacy UICC via a virtual UICC.

In a further exemplary embodiment of the apparatus above, determining whether the physical component is an secure module which supports subscription provisioning is based upon ATR bits provided by the physical component or a command sequence.

In another exemplary embodiment of any one of the apparatus above, instructing the physical component is a part of a PPS procedure.

In a further exemplary embodiment of any one of the apparatus above, the instructing means includes means for instructing the physical component to swap contents of an elementary file.

In another exemplary embodiment of any one of the apparatus above, the physical component has a default setting to operate as a legacy UICC.

In a further exemplary embodiment of any one of the apparatus above, the physical component stores a USIM, an ISIM, a SIM, a R-UIM application and/or a CSIM.

In another exemplary embodiment of any one of the apparatus above, the physical component is an eUICC.

In a further exemplary embodiment of any one of the apparatus above, a legacy UICC is a non-embedded UICC.

Another exemplary embodiment in accordance with this invention provides an apparatus enabling use of multiple subscriber identity module applications in UICCs. The apparatus includes means for downloading (e.g., a processor) a first subscription related data to a device, where subscription related data provides information for operating in a wireless network; means for storing (e.g., a processor) the first subscription related data on a memory component of a device, where the device includes a UICC storing a second subscription; and means for operating (e.g., a processor) the device as a multiple profile device using the first subscription and the second subscription.

In a further exemplary embodiment of the apparatus above, operation of the first subscription is conditioned on the presence of the UICC.

In another exemplary embodiment of any one of the apparatus above, the memory component is removable.

In a further exemplary embodiment of any one of the apparatus above, the UICC is a legacy UICC or a secure module which supports subscription provisioning.

In another exemplary embodiment of any one of the apparatus above, the subscription includes a USIM subscription, an ISIM subscription, a SIM subscription, a R-UIM subscription and/or a CSIM subscription.

In a further exemplary embodiment of any one of the apparatus above, the apparatus also includes means for designating one of the first subscription and the second subscription as a primary subscription and the other as a secondary subscription.

In another exemplary embodiment of any one of the apparatus above, the apparatus also includes means for receiving an input from a user indicating which of the first subscription and the second subscription to designate as the primary subscription.

In a further exemplary embodiment of any one of the apparatus above, the first subscription is designated as the secondary subscription.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as nonlimiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the E-UTRAN (UTRAN-LTE) system, it should be appreciated that the exemplary embodiments of this invention are not limited for use with only this one particular type of wireless communication system, and that they may be used to advantage in other wireless communication systems such as for example (WLAN, UTRAN, GSM as appropriate).

It should be noted that the tei is “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names used for the described items (e.g., SIM, UICC, etc.) are not intended to be limiting in any respect, as these items may be identified by any suitable names.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. A method comprising:
Determining, with an application of a device, whether a physical component of the device is a secure module which supports subscription provisioning;
in response to determining that the physical component is a secure module which supports subscription provisioning, instructing the physical component to operate as a UICC; and
provision a subscription via a virtual UICC of more than one virtual UICC of the UICC, where the virtual UICC is specific to the device.

2. The method of claim 1, where determining whether the physical component is an secure module which supports subscription provisioning is based upon answer to reset bits provided by the physical component or a command sequence.

3. The method of claim 1, where instructing the physical component comprises a part of a protocol and parameter selection procedure.

4. The method of claim 1, where instructing the physical component comprises instructing the physical component to swap contents of an elementary file.

5. (canceled)

6. (canceled)

7. A method comprising:
downloading a first subscription related data to a device, where subscription related data provides information for operating in a wireless network;
based on credentials associated with the first subscription, storing the first subscription related data on a memory component of a device, where the device comprises a UICC storing a second subscription in a virtual UICC of more than one virtual UICC of the UICC, where the virtual UICC is specific to the device; and
operating the device as a multiple profile device using the first subscription and the second subscription.

8. (canceled)

9. (canceled)

10. (canceled)

11. (canceled)

12. The method of claim 7, further comprising designating one of the first subscription and the second subscription as a primary subscription and the other as a secondary subscription.

13. The method of claim 12, further comprising receiving an input from a user indicating which of the first subscription and the second subscription to designate as the primary subscription.

14. The method of claim 12, where the first subscription is designated as the secondary subscription.

15. An apparatus, comprising at least one processor; and at least one memory including computer program code, the at least one memory and the computer program code configured to, with the at least one processor, cause the apparatus to perform at least the following:
to determine, with an application, whether a physical component of a device is a secure module which supports subscription provisioning;
in response to determining that the physical component is a secure module which supports subscription provisioning, to instruct the physical component to operate as a UICC; and
to provision a subscription via a virtual UICC of more than one virtual UICC of the UICC, where the virtual UICC is specific to the device.

16. The apparatus of claim 15, where determining whether the physical component is an secure module which supports subscription provisioning is based upon answer to reset bits provided by the physical component or a command sequence.

17. The apparatus of claim 15, where instructing the physical component comprises a part of a protocol and parameter selection procedure.

18. The apparatus of claim 15, where, when instructing the physical component, the at least one memory and the computer program code are further configured to cause the apparatus to instruct the physical component to swap contents of an elementary file.

19. (canceled)

20. The apparatus of claim 15, where the physical component stores at least one of: a USIM, an ISIM, a SIM, a R-UIM and a CSIM.

21. An apparatus, comprising at least one processor; and at least one memory including computer program code, the at least one memory and the computer program code configured to, with the at least one processor, cause the apparatus to perform at least the following:
to download a first subscription related data to a device, where subscription related data provides information for operating in a wireless network;
to store the first subscription related data on a memory component of a device, where the device comprises a UICC;
to, based on credentials associated with the first subscription, store a second subscription in a virtual UICC of more than one virtual UICC of the UICC, where the virtual UICC is specified to the device; and
to operate the device as a multiple profile device using the first subscription and the second subscription.

22. The apparatus of claim 21, where operation of the first subscription is conditioned on the presence of the UICC.

23. (canceled)

24. The apparatus of claim 21, where the UICC is one of: a legacy UICC and a secure module which supports subscription provisioning.

25. The apparatus of claim 21, where the subscription comprises at least one of: a USIM, an ISIM, a SIM, a UIM and a CSIM.

26. The apparatus of claim 21, where the at least one memory and the computer program code are further configured to cause the apparatus to designate one of the first subscription and the second subscription as a primary subscription and the other as a secondary subscription.

27. The apparatus of claim 26, where the at least one memory and the computer program code are further configured to receive an input from a user indicating which of the first subscription and the second subscription to designate as the primary subscription.

28. The apparatus of claim 26, where the first subscription is designated as the secondary subscription.

29-56. (canceled)

57. A computer program product comprising a non-transitory computer-readable storage medium bearing computer program code embodied therein for use with a computer, the computer program code comprising code for performing the method of claim 1.

58. A computer program product comprising a non-transitory computer-readable storage medium bearing computer program code embodied therein for use with a computer, the computer program code comprising code for performing the method of claim 7.
